(19) United States
(12) Patent Application Publication
(10) Pub. No.: US 2026/0051084 A1
(43) Pub. Date: Feb. 19, 2026

(54) CULTURAL ADAPTATION OF IMAGES USING GENERATIVE ARTIFICAL INTELLIGENCE

(71) Applicant: Adobe Inc., San Jose, CA (US)

(72) Inventors: Akhil EPPA, San Jose, CA (US); Mayank ANAND, Fremont, CA (US); Divyanshu GOYAL, Sunnyvale, CA (US)

(21) Appl. No.: 18/808,731

(22) Filed: Aug. 19, 2024

(51) Int. Cl. G06T 11/00; G06F 40/279

(52) U.S. Cl. CPC G06T 11/00; G06F 40/279

(57) ABSTRACT

Some aspects relate to technologies providing a framework for generating culturalized images using generative models. In accordance with some aspects, a source image is received, and an image description of that image is generated using a first model. One or more cultural guidelines are identified using the image description and a target region. A culturalized description is generated by a second model based on the image description and the one or more cultural guidelines, and a culturalized image is generated by a third model using the culturalized description.

### BACKGROUND

Adapting content to various conditions involves taking input and converting that input to conform to those various conditions. One example of adapting content is to adapt images to comport with different cultures, adding various culturally significant elements to an image while retaining underlying content, style, or structure. Adapting images to a particular culture generates an image that is more familiar to and that is more likely to resonate with persons of that culture. This adaptation poses various challenges, including identifying image elements, determining culturally significant elements that may or may not be present in those images, resolving ambiguity, and incorporating context in an image to generate a culturally adapted image. One particular challenge is the ability to determine whether culturally significant concepts are present in the inputs or the results and adapting those inputs or results according to those concepts.

### SUMMARY

Some aspects of the present technology relate to, among other things, systems and methods for culturally adapting images so that source images can be adapted so as to resonate with persons of another culture by generating culturalized versions of the source images for target regions. In accordance with some aspects of the technology described herein, when an input is received to generate a culturally adapted version of a source image for a target region, an image description of the source image is generated. In at least one embodiment, an image description for a source image comprises text generated using a generative model, such as a generative adversarial network (“GAN”), a variational autoencoder (“VAE”), a diffusion model (“DM”), a large language model (“LLM”), or other such generative models, described herein. The generative model can be an off-the-shelf model (e.g., ChatGPT, Gemini, LLAMA, etc.), or it can be a custom model trained to generate an image description of a source image.

The image description is used to identify cultural concepts contained in the source image. In at least one embodiment, cultural concepts are identified from the image description using a generative model, as described herein. The generative model used to identify cultural concepts can be the same generative model used to generate the image description, or it can be a different generative model (e.g., of a different type, version, etc.). In at least one embodiment, a structured dataset of previously determined cultural concepts is used by the generative model to identify the cultural concepts in the image description.

The identified cultural concepts are used to generate a culturalized description of the source image for a target region using a generative model, as described herein. In accordance with some aspects, cultural guidelines for the identified cultural concepts for the target region are accessed and provided as input with the image description to the generative model. The generative model used to generate culturalized descriptions can be the same generative model used to generate the image description, can be the same generative model used to identify the cultural concepts, or it can be a different generative model (e.g., of a different type, version, etc.).

The generated culturalized description is used to generate a culturalized image corresponding to the source image for the target region using a generative model, as described herein. The generative model used to generate the culturalized image can be the same as the other generative models described above or can be a different generative model (e.g., of a different type, version, etc.).

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system to generate a culturalized image, in accordance with implementations of the present disclosure;

FIG. 2 is a block diagram illustrating an exemplary data flow to generate a culturalized image, in accordance with some implementations of the present disclosure;

FIG. 3 is a flow diagram illustrating a method for generating a culturalized image, in accordance with some implementations of the present disclosure;

FIG. 4 is a block diagram illustrating an example subsystem for generating image descriptions, in accordance with some implementations of the present disclosure;

FIG. 5 is a block diagram illustrating an example subsystem for identifying cultural concepts, in accordance with some implementations of the present disclosure;

FIG. 6 is a block diagram illustrating an example subsystem for generating culturalized descriptions, in accordance with some implementations of the present disclosure;

FIG. 7 is a block diagram illustrating an example subsystem for generating culturalized images, in accordance with some implementations of the present disclosure;

FIG. 8 is a flow diagram illustrating a method for generating culturalized images, in accordance with some implementations of the present disclosure;

FIG. 9A is a block diagram illustrating a hierarchy of cultural guidelines, in accordance with some implementations of the present disclosure;

FIG. 9B is a block diagram illustrating an example of cultural guidelines, in accordance with some implementations of the present disclosure;

FIG. 10 is a flow diagram illustrating a method for generating and storing structured data for cultural guidelines, in accordance with some implementations of the present disclosure; and

FIG. 11 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, a “culturalized image” is an image that is altered to highlight cultural elements of a targeted culture (e.g., a region, country, or sub-culture of a region or country). A culturalized image is also referred to as a culturally translated image or a culturally adapted image.

As used herein, a “prompt” is an input to a generative model (e.g., an LLM or some other generative model) that causes the generative model to generate a response. In some instances, a prompt is generated by another generative model.

As used herein, a “source image” is an input image that is to be culturally adapted or culturalized. In some instances, a source image has existing cultural elements (e.g., from a first culture) that are to be replaced with cultural elements from a second culture. In some instances, a source image is culturally ambiguous. In some instances, a source image is or includes a description of the source image.

As used herein, a “cultural guidelines hierarchy” is an organization of set of data that includes regions, cultural concepts, entities, and/or cultural guidelines. In some instances, a cultural guidelines hierarchy is organized by regions, with cultural concepts for each region, entities for each cultural concept, and cultural guidelines for each entity. In some instances, a cultural guidelines hierarchy is organized by cultural concepts, or by entities, or by cultural guidelines.

As used herein, a “region” is a cultural region (e.g., a country, populace, area within a country, area comprising multiple countries, and/or a subdivision of these). In some instances, a region comprises a cultural or country identity that has identifiable cultural concepts. In some instances, a country can have multiple regions.

As used herein, a “target region” is a desired region for culturalization. In some instances, for example, image culturalization is to adapt a source image to the cultural identity of a target region.

As used herein, a “cultural concept” is one of a broad category of cultural elements that can be used for cultural adaptation. Examples of cultural concepts include such things as birds, animals, plants, food, movies, urban elements, rural elements, cars, folklore, etc. In some instances, a cultural hierarchy includes a determined number of cultural concepts, with at least one entity for each of those cultural concepts, for each region.

As used herein, an “entity” is an instance of a culturally significant cultural concept for a region. In some cases, for a particular cultural concept and region, there are one or more entities of that cultural concepts that are culturally significant to that region. For example, for a particular region (e.g., Japan) and a particular cultural concept (e.g., Birds), there can be several entities that are culturally significant birds of Japan. In some cases, an entity is associated with multiple regions. In some instances, an entity is associated with a single cultural concept per region.

As used herein, a “cultural guideline” is a culturally significant aspect of an entity. In some instances, an entity has several cultural guidelines; for example, a crow, which is a bird found in Japan, can have several different cultural guidelines that indicate how a crow is viewed in Japan. In some instances, cultural guidelines for an entity in one culture are different than cultural guidelines for that same entity in another culture.

As used herein, an “image description” is a description of an image that is to be culturalized. In some instances, an image description is included with a source image. In some instances, an image description is generated from a source image.

As used herein, a “culturalized description” is an image description that is altered according to cultural guidelines so that the culturalized description of the image can be used to generate a culturalized image. In some instances, a culturalized description includes style and/or structure elements retained from the image description.

As used herein, a “style” of an image comprises the elements of an image beyond the specific visual elements. For example, an image style can be blurry, bright, dark, warm, cold, cartoonish, etc. In some instances, an image style is derived from the image. In some instances, an image style is included with an image (e.g., as data and/or metadata).

As used herein, a “structure” of an image comprises the arrangement of visual elements of an image in relationship to each other and/or within the image. In some instances, structure is derived from the image. In some instances, structure is included with an image (e.g., as data and/or metadata).

### Overview

Generating culturalized images is challenging for many reasons. First, it is often difficult to determine which aspects of an image can be culturally adapted (or culturalized). Second, it is often difficult to adapt images by, for example, determining a cultural equivalence between elements of different cultures. Typical approaches are time and resource intensive. One such conventional approach involves a human user manually identifying key ideas conveyed by the source image and then gathering information about these key ideas as they relate to a new cultural setting in order to devise a cultural translation (e.g., from elements of the source culture to elements of the target culture). The user must then search for existing images using relevant keywords related to the new cultural context or create new images for the new cultural context, and then manually edit the source image to substitute elements based on the cultural translation in order to generate a culturalized image. Because there is typically no set metric for such translation, results can be inconsistent. Also, because such translations are typically performed with considerable human interaction (e.g., to identify elements in the source or target culture), they are error-prone and often inconsistent (e.g., translating some elements while missing others). Additionally, such translations are typically very specific in that a translation from, for example, Japanese culture to Indian culture has no bearing on or relevance to a translation from a Japanese culture to Brazilian culture or a translation from Indian culture to Brazilian culture. Additionally, such methods typically do not scale well, failing to account for new elements or new cultures.

Aspects of the technology described herein address the problems of conventional image culturalization by providing an image culturalization system that efficient and effectively culturalizes images by leveraging generative models, such as large language models (LLMs), and a hierarchy of culturalized guidelines. The cultural guidelines hierarchy sets forth a number of regions, a number of cultural concepts for the regions, one or more entities for each cultural concept for each region, and one or more cultural guidelines for each entity within each cultural concept for each region.

In operation, the image culturalization system receives a source image and a target region (although in some aspects, multiple source images and/or multiple target regions can be received). In some configurations, the source image is generic (e.g., does not include culturally identified elements). The source image is processed by a generative model to generate an image description of the source image. In some configurations, the generative model is a multi-modal LLM such as GPT-4. In some configurations, the generative model is a custom generative model, specifically tuned to generate an image description of a source image.

The image culturalization system uses the image description of the source image to identify cultural concepts of the source image by using a generative model to process the image description. In some configurations, the generative model is an LLM such as GPT-4. In some configurations, the generative model is a custom generative model, specifically tuned to identify cultural concepts of an image description so that, for example, the presence of elements in the source image that could be used to culturally adapt an image can be identified. In some aspects, the generative model leverages a predefined list of cultural concepts in the cultural guidelines hierarchy to identify the cultural concepts in the image description.

The image culturalization system uses the image description of the source image, the cultural concepts, and the target region to generate a culturalized description for the target region. More particularly, culturalized guidelines are retrieved from the cultural guidelines hierarchy for the cultural concepts and the target region. A generative model generates the culturalized description using the image description and culturalized guidelines.

The image culturalization system generates a culturalized image by providing the culturalized description to a generative model that generates images from text prompts. In some aspects, the generative model also uses the source image to determine style and structure information for generating the culturalized image.

As an illustrative example, a source image of a daytime scene with a boardwalk winding through vegetation can be used to generate a culturalized version of the image by using a generative model to generate an image description of the source image (e.g., “A wooden boardwalk stretches out into the distance, surrounded by tall green grasses and wildflowers. The sky is a vibrant blue with wispy white clouds scattered throughout. In the distance, there are trees and shrubs, adding to the natural landscape. The scene is peaceful and serene, inviting one to take a leisurely stroll and enjoy the beauty of nature.”). This image description is then used to identify cultural concepts of the image (e.g., “plants,” “flowers,” “visual arts,” etc.), and these cultural concepts are used to generate a culturalized description of the image for a target culture (e.g., India). In particular, the cultural concepts are used to retrieve cultural guidelines for the target region and provide the image description to a generative model for generating the culturalized description. This culturalized description could be, for example: “A wooden pathway meanders through a lush meadow, dotted with vibrant Marigolds and delicate Jasmine, their fragrances mingling in the air. The sky above is a clear azure, adorned with soft, cotton-like clouds. In the distance, Neem and Mango trees contribute to the verdant scenery, enhancing the tranquil ambiance. This serene setting beckons one to amble leisurely, embracing the warmth and harmony of nature's embrace.” This culturalized description is then provided as input to a generative model to generate a culturalized image corresponding to the culturalized description (e.g., with the Marigolds, the Jasmine, the Neem and Mango trees, etc.). A different target culture (e.g., Japan) generates a different culturalized description, with culturally significant Japanese plants, flowers, and visual elements.

Aspects of the technology described herein provide a number of improvements over existing technologies. For example, the steps of the aforementioned process to generate culturally adapted versions of a source image can be performed automatically and with no human intervention. A user can select a source image and one or more target regions, and the steps of generating an image description, identifying cultural concepts, generating culturalized descriptions, and generating culturalized images can be performed automatically, as described herein, with the output of one operation being used as the input of a subsequent operation. Additionally, using the various generative models described herein enables a more consistent cultural adaptation of images so that, for example, a single image can be culturally adapted to a number of cultures or a set of images can be culturally adapted together, with consistent results. Another advantage of the technology described herein is that the generative models being applied automatically enables better results, since, for example, a single source image can yield several image descriptions and the best of those can be chosen for cultural concept identification. Similarly, several sets of cultural concepts can be identified, and the best of those can be used to generate the culturalized descriptions of the source image. Finally, the technology described herein can be used on any arbitrary type of image, including, but not limited to, photographs, drawings, animations, etc., since the technology described herein can be applied consistently, efficiently, and rapidly.

### Example Systems and Methods for Generating a Culturalized Image

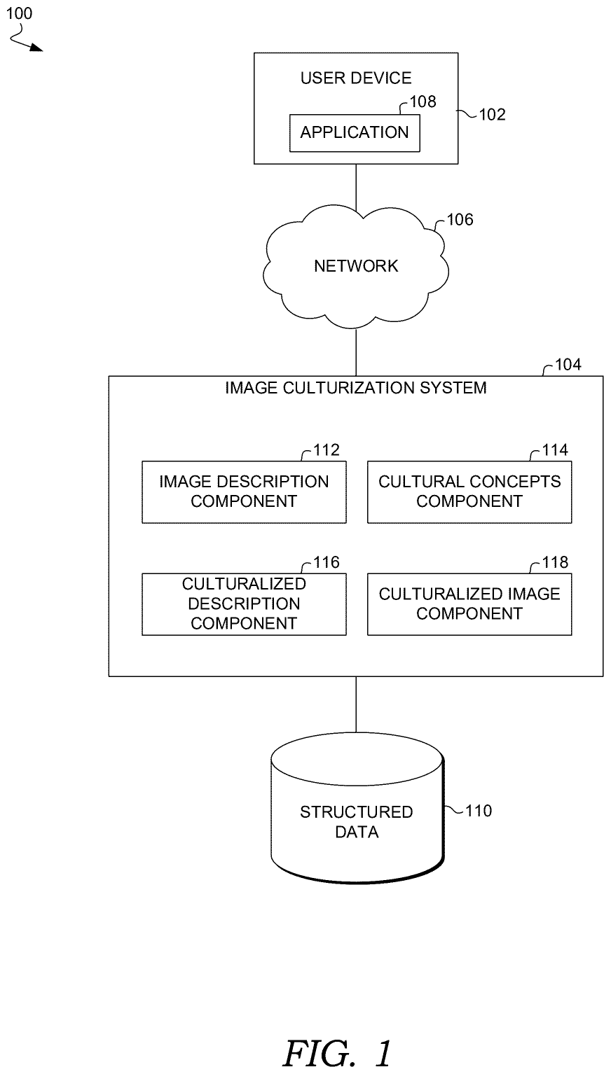

With reference now to the drawings, FIG. 1 is a block diagram 100 illustrating an exemplary system to generate a culturalized image, in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

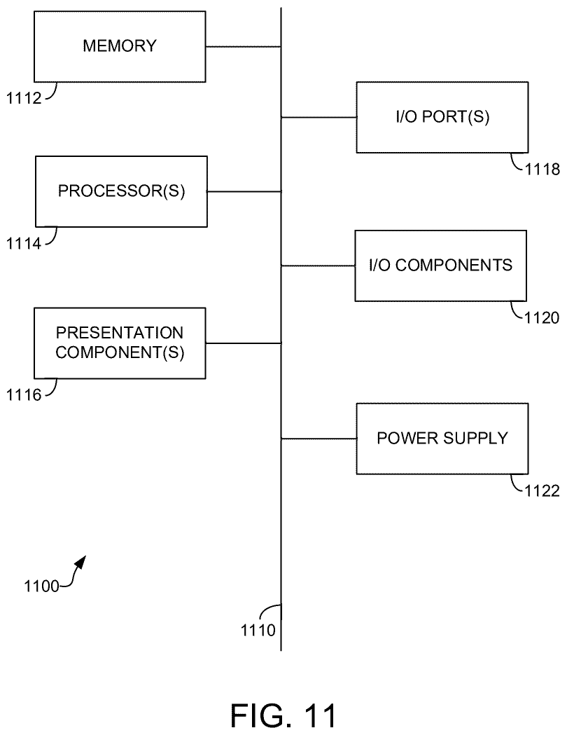

The system illustrated in block diagram 100 is an example of a suitable architecture for implementing certain aspects of the present disclosure. Among other components not shown, the system illustrated in block diagram 100 includes a user device 102 and an image culturalization system 104. Each of the user device 102 and the image culturalization system 104 shown in FIG. 1 can comprise one or more computer devices, such as the computing device 1100 of FIG. 11, described below. As shown in FIG. 1, the user device 102 and the image culturalization system 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system illustrated in block diagram 100 within the scope of the present technology. Each device or server may comprise a single device or multiple devices cooperating in a distributed environment. For instance, the image culturalization system 104 could be provided by multiple server devices collectively providing the functionality of the image culturalization system 104, as described herein. Additionally, other components not shown may also be included within the network environment.

The user device 102 can be a client device on the client-side of the operating environment illustrated in block diagram 100, while the image culturalization system 104 can be on the server-side of the operating environment illustrated in block diagram 100. The image culturalization system 104 can comprise server-side software designed to work in conjunction with client-side software on the user device 102 so as to implement any combination of the features and functionalities discussed in the present disclosure. For example, the user device 102 can include an application 108 for interacting with the image culturalization system 104. The application 108 can be, for instance, a web browser or a dedicated application for providing functions, such as those described herein. This division of an operating environment illustrated in block diagram 100 is provided to illustrate one example of a suitable environment. There is no requirement for each implementation that any combination of the user device 102 and the image culturalization system 104 remain as separate entities. While the operating environment illustrated in block diagram 100 illustrates a configuration in a networked environment with a separate user device and image culturalization system, it should be understood that other configurations can be employed in which aspects of the various components are combined. For instance, in some aspects, aspects of the image culturalization system 104 can be implemented in part or in whole by the user device 102.

The user device 102 may comprise any type of computing device capable of use by a user. For example, in one aspect, a user device may be the type of computing device 1100 described in relation to FIG. 11 herein. By way of example and not limitation, the user device 102 may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user may be associated with the user device 102 and may interact with the image culturalization system 104 via the user device 102.

In some configurations, the image culturalization system 104 is implemented as part of a conversational artificial intelligence (“AI”) assistant that generates responses to user queries through natural language interaction. In such instances, the image culturalization system 104 uses artificial intelligence and machine learning algorithms to understand user queries, interpret context, and generate responses by accessing relevant information from various sources, including data from the structured data 110. In at least one embodiment, the image culturalization system 104 uses one or more generative models such as those described herein to understand user queries, interpret context, and generate culturalized images using systems, methods, operations, and techniques such as those described herein.

As shown in FIG. 1, the image culturalization system 104 comprises an image description component 112, a cultural concepts component 114, a culturalized description component 116, and/or a culturalized image component 118. The modules/components of the image culturalization system 104 may be in addition to other components that provide further additional functions beyond the features described herein. The image culturalization system 104 can be implemented using one or more server devices, one or more platforms with corresponding application programming interfaces, cloud infrastructure, and the like. While the image culturalization system 104 is shown as separate from the user device 102 in the configuration of FIG. 1, it should be understood that in other configurations, some or all of the functions of the image culturalization system 104 can be provided on the user device 102. Additionally, in some configurations, one or more of the components of the image culturalization system 104 shown in FIG. 1 can be provided by the user device 102 and/or another location not shown in FIG. 1. The components can be provided by a single entity or multiple entities.

In some aspects, the functions performed by components of the image culturalization system 104 are associated with one or more applications, services, or routines. In particular, such applications, services, or routines may operate on one or more user devices and servers, may be distributed across one or more user devices and servers, or may be implemented in the cloud. Moreover, in some aspects, these components of the image culturalization system 104 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in the example system illustrated in block diagram 100, it is contemplated that in some aspects, functionality of these components can be shared or distributed across other components.

Given an input from a user device (e.g., user device 102) to generate a culturalized image based on a source image for one or more target regions, the image culturalization system 104 uses the image description component 112 to generate an image description of the source image. In at least one embodiment, the image description component 112 uses a generative model (e.g., an LLM) to generate the image description using systems, methods, techniques, and operations described herein. In some configurations, the image description component 112 receives, as input, the source image, and generates a prompt (e.g., “Describe this image. Do not include the word ‘image’ in the response or do not reference the image in the output. The generated output would be used to generate a new image.”) to generate the image description. The prompt is then provided to the generative model to generate the image description (e.g., “A wooden boardwalk stretches into the distance, surrounded by tall green grasses and wildflowers. The sky is a vibrant blue with wispy white clouds scattered throughout. In the distance, there are trees and shrubs, adding to the natural landscape. The scene is peaceful and serene, inviting one to take a leisurely stroll and enjoy the beauty of nature.”).

In some configurations, the image description component 112 generates a prompt using a user interface (not shown in FIG. 1) wherein a user can upload a source image and select one or more target regions to generate one or more culturalized images. In some configurations, the image description component 112 generates a plurality of prompts when the image culturalization system 104 is to culturalize a plurality of images using, for example, a batch process.

In some aspects, the image description component 112 generates a prompt based on a natural language query received from the user device 102 (or at least a portion thereof) and provides the prompt to the generative model to generate the image description. In some configurations, the prompt can include text instructing the generative model regarding how to generate the text for the output (e.g., do not include explanations, do not use certain words, perform conversions, etc.). In some instances, the prompt is generated to include additional information to help guide the generative model in generating the image description. In some aspects, one or more query expansion operations can be performed for the natural language query. By way of example only and not limitation, synonym expansion could be performed to add synonyms for words/phrases in the query, and/or acronym expansion could be performed to add words/phrases for acronyms in the query. The query expansion operations can be performed by the generative model or separately.

The generative model used by the image description component 112 to generate image descriptions for image culturalization can comprise a multi-modal language model that includes a set of statistical or probabilistic functions to perform Natural Language Processing (NLP) in order to understand, learn, and/or generate human natural language content based on source images. For example, a language model can be a tool that determines the probability of a given sequence of words occurring in a sentence or natural language sequence. Simply put, a language model can be a model that is trained to predict the next word in a sentence. A language model is called a large language model (LLM) when it is trained on an enormous amount of data and/or has a large number of parameters. Some examples of LLMs include those described above. These models have capabilities ranging from writing a simple essay to generating complex computer codes-all with limited to no supervision. In some configurations, a language model can receive image input (e.g., a source image) and provide a description of the image. Accordingly, an LLM can comprise a deep neural network that is very large (billions to hundreds of billions of parameters) and understands, processes, and produces human natural language by being trained on massive amounts of text. These models can predict future words in a sentence letting them generate sentences similar to how humans talk and write or otherwise communicate in a form dictated, for instance, by a prompt. In some aspects, the generative model used by the image description component 112 to generate image descriptions for image culturalization can be an off-the-shelf model or can be a custom model. In some aspects, the generative model used by the image description component 112 to generate image descriptions for image culturalization can comprise one or more of the models described herein and/or other such models.

In accordance with some aspects, the generative model used by the image description component 112 comprises a neural network. As used herein, a neural network comprises multiple operational layers, including an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

In some configurations, the generative model used by the image description component 112 is a pre-trained model (e.g., GPT-4) that has not been fine-tuned. In other configurations, the generative model is a model that is built and trained from scratch or a pre-trained model that has been fine-tuned. In such configurations, the generative model can be trained or fine-tuned using training data. During training, weights associated with each neuron can be updated. Originally, the generative model can comprise random weight values or pre-trained weight values that are adjusted during training. In one aspect, the generative model is trained using backpropagation. The backpropagation process comprises a forward pass, a loss function, a backward pass, and a weight update. This process is repeated using the training data. The goal is to update the weights of each neuron (or other model component) to cause the generative model to produce useful image descriptions given source images. Once trained, the weight associated with a given neuron can remain fixed. The other data passing between neurons can change in response to a given input. Retraining the network with additional training data can update one or more weights in one or more neurons.

The image culturalization system 104 uses the cultural concepts component 114 to identify cultural concepts of the source image using the image description generated by the image description component 112. In at least one embodiment, the cultural concepts component 114 uses a generative model (e.g., an LLM) to identify the cultural concepts using systems, methods, operations, and techniques described herein. In some aspects, the cultural concepts component 114 leverages a pre-defined list of cultural concepts to assist in identifying particular cultural concepts from the pre-defined list that are present in the image description. In some configurations, the cultural concepts component 114 receives, as input, the image description (e.g., as described above) and generates a prompt (e.g., “Given the list of cultural concepts and an image description, identify relevant concepts from the image description.”) to identify the cultural concepts of the source image. In some configurations, the cultural concepts component 114 receives, as input, the source image. In some configurations, the cultural concepts component 114 does not receive the source image as input. In some configurations, the cultural concepts component 114 returns a formatted list of concepts (e.g., {“Flowers”, “Plants”, “Visual Arts”}) in response to the prompt. In some configurations, the cultural concepts component 114 generates a plurality of prompts when the image culturalization system 104 is to culturalize a plurality of images using, for example, a batch process.

In some aspects, the cultural concepts component 114 generates a prompt based on the image description and in some cases, generates a natural language query received from the user device 102 (or at least a portion thereof) and provides the prompt to the generative model to identify the cultural concepts. In some configurations, the prompt can include text instructing the generative model regarding how to generate the text for the output (e.g., do not include explanations, do not use certain words, perform conversions, etc.). In some instances, the prompt is generated to include additional information to help guide the generative model in identifying the cultural concepts, as described above in connection with the image description component 112.

In some aspects, the generative model used by the cultural concepts component 114 to identify the cultural concepts for image culturalization can comprise a language model, can comprise a neural network, can be a pre-trained model (e.g., GPT-4) that has not been fine-tuned, or can be a fine-tuned model, all as described above in connection with the image description component 112. In some aspects, the generative model used by the cultural concepts component 114 to identify cultural concepts for image culturalization can be an off-the-shelf model or can be a custom model. In some aspects, the generative model used by the cultural concepts component 114 to identify cultural concepts for image culturalization can comprise one or more of these and/or other such models.

The image culturalization system 104 uses the culturalized description component 116 to generate a culturalized description of the source image using the cultural concepts identified by the cultural concepts component 114, concept guidelines (e.g., from structured data 110), and one or more target regions. In some instances, structured data 110 comprises a cultural guidelines hierarchy that sets forth a hierarchy of regions, cultural concepts, entities, and/or cultural guidelines. In at least one embodiment, culturalized description component 116 uses a generative model (e.g., an LLM) to generate a culturalized description using systems, methods, operations, and techniques described herein. In some configurations, the culturalized description component 116 receives, as input, the cultural concepts and the target regions and generates a prompt (e.g., “Given a list of cultural concepts, guidelines relevant to those cultural concepts, and a target region, generate a culturalized description in English. The culturalized description will be used to generate an image.”) to generate the culturalized description. In some configurations, the culturalized description component 116 returns one or more image descriptions (e.g., for India, “A wooden pathway meanders through a lush meadow, dotted with vibrant Marigolds and delicate Jasmine, their fragrances mingling in the air. The sky above is a clear azure, adorned with soft, cotton-like clouds. In the distance, Neem and Mango trees contribute to the verdant scenery, enhancing the tranquil ambience. This serene setting beckons one to amble leisurely, embracing the warmth and harmony of nature's embrace.”). In some configurations, the culturalized description component 116 receives, as input, the source image. In some configurations, the culturalized description component 116 receives, as input, the image description. In some configurations, the culturalized description component 116 does not receive the source image as input. In some configurations, the culturalized description component 116 does not receive the image description as input. In some configurations, the culturalized description component 116 generates a plurality of prompts when the image culturalization system 104 is to culturalize a plurality of images using, for example, a batch process.

In some aspects, the culturalized description component 116 generates a prompt based on a natural language query received from the user device 102 (or at least a portion thereof) and provides the prompt to the generative model to generate culturalized descriptions. In some configurations, the prompt can include text instructing the generative model regarding how to generate the text for the output (e.g., do not include explanations, do not use certain words, perform conversions, etc.). In some instances, the prompt is generated to include additional information to help guide the generative model in generating the culturalized descriptions, as described above in connection with the image description component 112.

In some aspects, the generative model used by the culturalized description component 116 to generate culturalized descriptions for image culturalization can comprise a language model, can comprise a neural network, can be a pre-trained model (e.g., GPT-4) that has not been fine-tuned, or can be a fine-tuned model, all as described above in connection with the image description component 112. In some aspects, the generative model used by the culturalized description component 116 to generate culturalized descriptions for image culturalization can be an off-the-shelf model or can be a custom model. In some aspects, the generative model used by the culturalized description component 116 to generate culturalized descriptions for image culturalization can comprise one or more of these and/or other such models.

The image culturalization system 104 uses the culturalized image component 118 to generate a culturalized version of the source image using the culturalized description generated by the culturalized description component 116. In at least one embodiment, culturalized image component 118 uses a multi-modal generative model to generate a culturalized image using systems, methods, operations, and techniques described herein. In some configurations, the culturalized image component 118 receives, as input, the culturalized descriptions and generates a prompt (e.g., “Generate an image using this description.”) to generate the culturalized image. In some configurations, the culturalized image component 118 receives, as input, the source image. In some configurations, the culturalized image component 118 does not receive the source image as input. In some configurations, the culturalized image component 118 receives one or more style or structure descriptions of the source image, as described herein. In some configurations, image style and/or image structure comprise elements of an image that are in addition to the visual elements of the image. For example, image style can be blurry, bright, dark, warm, cold, cartoonish, etc. In another example, image structure is the arrangement of visual elements of an image in relationship to each other and/or within an image. In at least one embodiment, image style and/or image structure are obtained by analyzing an image (e.g., an input image) using techniques described herein. In at least one embodiment, image style and/or image structure are provided with a source image as data or metadata. In some configurations, the culturalized image component 118 uses image style and/or image structure to generate a culturalized image description so that, for example, if a source image has a particular style and/or structure, that style and/or structure is retained in the culturalized image description. For example, if a source image is a “warm rural scene with a road in the foreground and mountains in the background,” a culturalized image description that retains style and/or structure would also be a “warm rural scene with a road in the foreground and mountains in the background” that includes the culturalized elements.

In some configurations, the culturalized image component 118 generates a plurality of prompts when the image culturalization system 104 is to culturalize a plurality of images using, for example, a batch process.

In some aspects, the culturalized image component 118 generates a prompt based on a natural language query received from the user device 102 (or at least a portion thereof) and provides the prompt to the generative model to generate culturalized images. In some configurations, the prompt can include text instructing the generative model regarding how to generate the culturalized image. In some instances, the prompt is generated to include additional information to help guide the generative model in generating the culturalized images, as described above in connection with the image description component 112.

In some aspects, the generative model used by the culturalized image component 118 to generate culturalized images can comprise a multi-modal language model, can comprise a neural network, can be a pre-trained generative model that has not been fine-tuned, or can be a fine-tuned model, all as described above in connection with the image description component 112. In some aspects, the generative model used by the culturalized image component 118 to generate culturalized images can be an off-the-shelf model or can be a custom model. In some aspects, the generative model used by the culturalized image component 118 to generate culturalized images can comprise one or more of these and/or other such models.

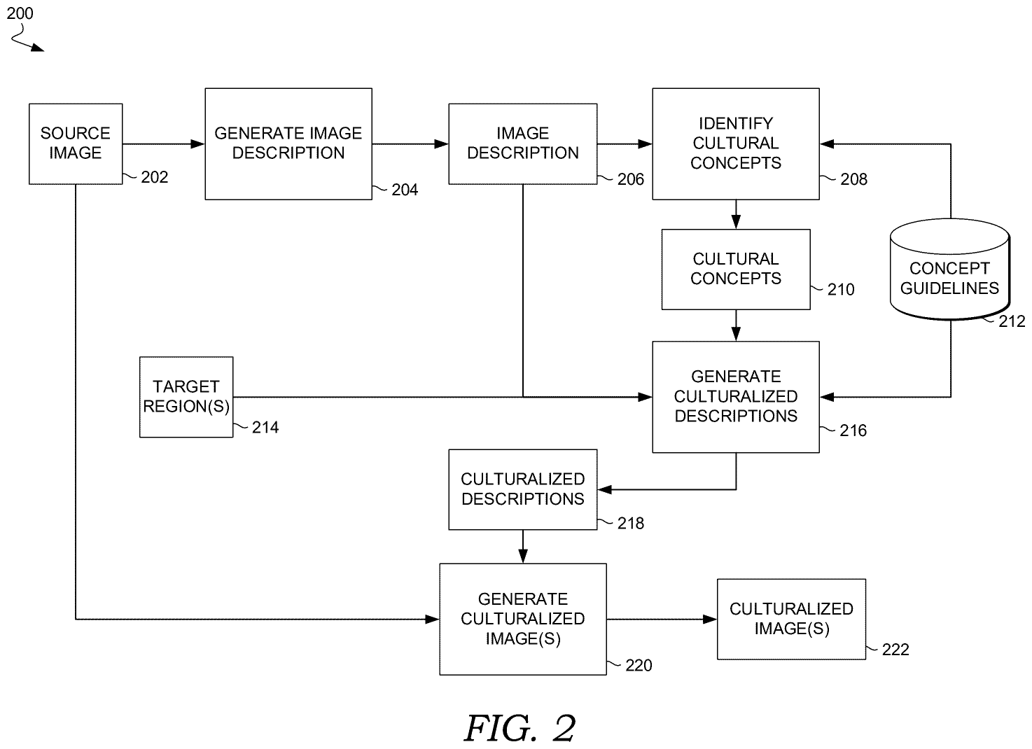

FIG. 2 is a block diagram 200 illustrating an exemplary data flow to generate a culturalized image, in accordance with some implementations of the present disclosure. In some configurations, a source image 202 is provided to a component such as the image description component 112 that performs one or more operations to generate an image description 204. In some configurations, the image description component 112 performs the one or more operations using a generative model (e.g., an LLM), as described above. As a result of the one or more operations to generate image description 204, an image description 206 is generated.

In some configurations, image description 206 is provided to a component, such as the cultural concepts component 114 that performs one or more operations to identify cultural concepts 208 in the image description 206. In some configurations, the cultural concepts component 114 performs the one or more operations using a generative model (e.g., an LLM), as described above. In some configurations, the cultural concepts component 114 performs one or more operations to identify cultural concepts 208 using a concept guidelines 212 datastore (e.g., a cultural concept guidelines datastore) which stores a cultural guidelines hierarchy that comprises structured data that is used to indicate cultural guidelines corresponding to cultural concepts for each identified region, as described herein. In some configurations, cultural guidelines corresponding to each cultural concept (e.g., birds, plants, food, etc.) and for each region (e.g., Japan, India, etc.) are generated and stored in the concept guidelines 212 datastore (e.g., a cultural concept guidelines datastore), as described herein. As a result of the one or more operations to identify cultural concepts 208, cultural concepts 210 are identified.

In some configurations, the cultural concepts 210 and a list of one or more target regions 214 are provided to a component such as the culturalized description component 116 that performs one or more operations to generate culturalized description(s) 216. In some configurations, the image description 206 is also provided to a component such as the culturalized description component 116 that performs one or more operations to generate culturalized description(s) 216. In some configurations, the culturalized description component 116 performs the one or more operations using a generative model (e.g., an LLM), as described above. In some configurations, the culturalized description component 116 that performs one or more operations to generate culturalized description(s) 216 employs one or more cultural guidelines identified from the concept guidelines 212 datastore based on the cultural concepts 210. As a result of the one or more operations to generate culturalized descriptions 216, the culturalized description(s) 218 are generated.

In some configurations, the culturalized description(s) 218 and the source image 202 are provided to a component such as the culturalized image component 118 that performs one or more operations to generate culturalized image(s) 220. In some configurations, the culturalized image component 118 performs the one or more operations using a generative model, as described above. As a result of the one or more operations to generate culturalized image(s) 220, culturalized image(s) 222 are generated.

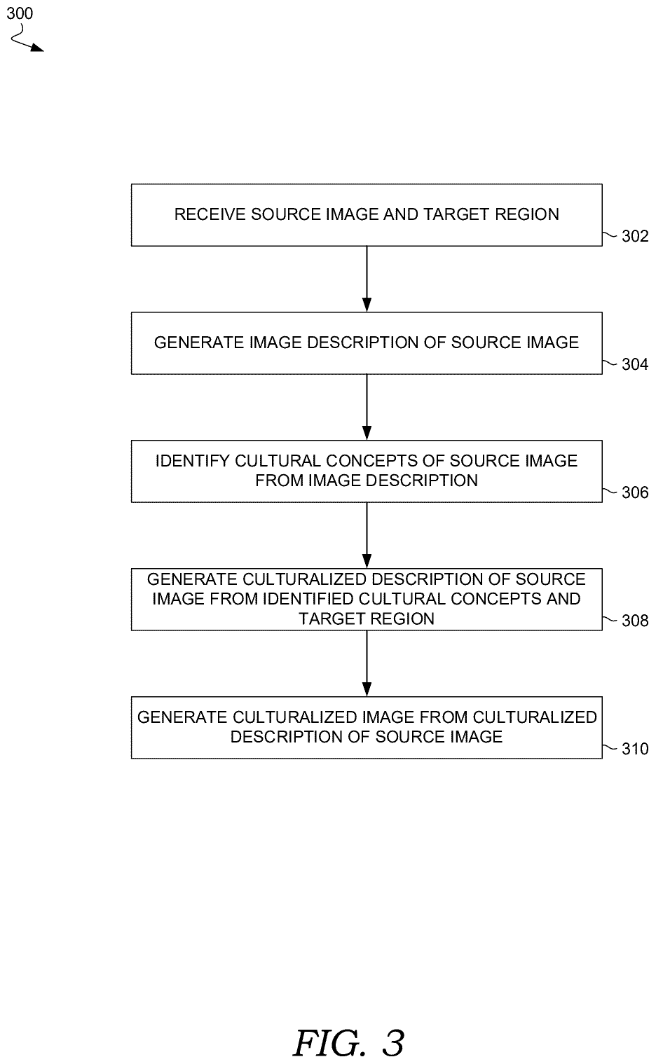

FIG. 3 is a flow diagram 300 illustrating a method for generating a culturalized image, in accordance with some implementations of the present disclosure. The method illustrated in FIG. 3 can be performed by, for instance, the image culturalization system 104 described herein at least in connection with FIG. 1. Each block of the method illustrated in FIG. 3 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), a plug-in to another product, or other such applications, services, products, or plug-ins.

At block 302, a source image and a target region are received from a user device such as user device 102, described herein at least in connection with FIG. 1. In at least one embodiment, the source image received from the user device is specified using a user interface to, for example, drag and drop the source image for image culturalization. In at least one embodiment, the source image is stored in a storage location accessible by the method for generating a culturalized image illustrated in FIG. 3. In some configurations, the source image is one of a plurality of source images to be used in the method for generating a culturalized image illustrated in FIG. 3 (e.g., using a batch process). In at least one embodiment, a target region is received from a user device. In at least one embodiment, the target region received from the user device is specified using a user interface to, for example, select the target region so that the source image can be used for image culturalization using the target region. In at least one embodiment, a plurality of target regions are received from a user device so that, for example, the source image is to be culturalized for a plurality of target regions.

At block 304, an image description of the source image received at block 302 is generated by a component such as the image description component 112. In some configurations, a prompt is generated to cause a language model (e.g., an LLM) to generate an image description, using systems, methods, operations, and techniques described herein. In some configurations, the prompt is stored in a datastore accessible by the language model. In some configurations, the image description generated at block 304 is stored in a datastore accessible at block 306, described below. In some configurations, the image description generated at block 304 is provided to a cultural concepts component 114, as described below in connection with block 306.

At block 306, cultural concepts of the source image received at block 302 are identified using the image description generated at block 304. In some configurations, the cultural concepts are identified by a component such as the cultural concepts component 114. In some configurations, a prompt is generated to cause a language model (e.g., an LLM) to identify cultural concepts, using systems, methods, operations, and techniques described herein. In some configurations, the prompt is stored in a datastore accessible by the language model. In some configurations, the cultural concepts identified at block 306 are stored in a datastore accessible at block 308, described below. In some configurations, the cultural concepts identified at block 306 are provided to a culturalized description component 116, as described below in connection with block 308.

At block 308, a culturalized description of the source image received at block 302 is generated using the cultural concepts identified at block 306 and the target region received at block 302. In some configurations, the culturalized description is generated by a component such as the culturalized description component 116 that identifies cultural guidelines for the cultural concepts in the target region and uses the cultural guidelines in conjunction with the image description to generate the culturalized description. In some configurations, a prompt is generated to cause a language model (e.g., an LLM) to generate a culturalized description, using systems, methods, operations, and techniques described herein. In some configurations, the prompt is stored in a datastore accessible by the language model. In some configurations, the culturalized description generated at block 308 is stored in a datastore accessible at block 310, described below. In some configurations, the culturalized description generated at block 308 is provided to a culturalized image component 118, as described below in connection with block 310.

At block 310, a culturalized image corresponding to the source image received at block 302 is generated using the culturalized description generated at block 306 based on the target region received at block 302. In some configurations, the culturalized image is generated by a component such as the culturalized image component 118. In some configurations, a prompt is generated to cause an image generation model to generate a culturalized image, using systems, methods, operations, and techniques described herein. In some configurations, the prompt is stored in a datastore accessible by the language model. In some configurations, the culturalized image generated at block 310 is stored in a datastore accessible by a user device such as user device 102, described herein at least in connection with FIG. 1. In some configurations, the source image is also used to generate the culturalized image. In some configurations, the style and/or structure information from the image is used to generate the cultural image as described herein.

In some configurations, the culturalized image generated at block 310 is provided to the user device for display using a user interface. In some configurations, the user device is the same as the user device from which a source image and a target region are received (e.g., at block 302). In some configurations, the user device is different than the user device from which a source image and a target region are received. In some configurations, after block 310, the method for generating a culturalized image illustrated in block diagram 300 terminates. In some configurations, after block 310, the method for generating a culturalized image illustrated in block diagram 300 continues at block 302 to receive a new source image and/or target region.

Although not illustrated in FIG. 3, in some configurations, the operations of the method for generating a culturalized image illustrated in block diagram 300 are performed in a different order than that described. In some configurations, where operations can be performed in a different order, some of the operations can be performed in parallel by a plurality of devices such as those described herein. Similarly, in some configurations, operations can be performed in a batch so that, for example, a plurality of images can be culturalized sequentially or in parallel for a single target region, or a single image can be culturalized sequentially or in parallel for a plurality of target regions, or a plurality of images can be culturalized sequentially or in parallel for a plurality of target regions. As an illustrative example, for a single source image and three target regions (e.g., Japan, India, and Brazil), block 302, 304, and 306 can first be performed, and then three parallel instances of blocks 308 and 310 can be performed in parallel for each of the target regions.

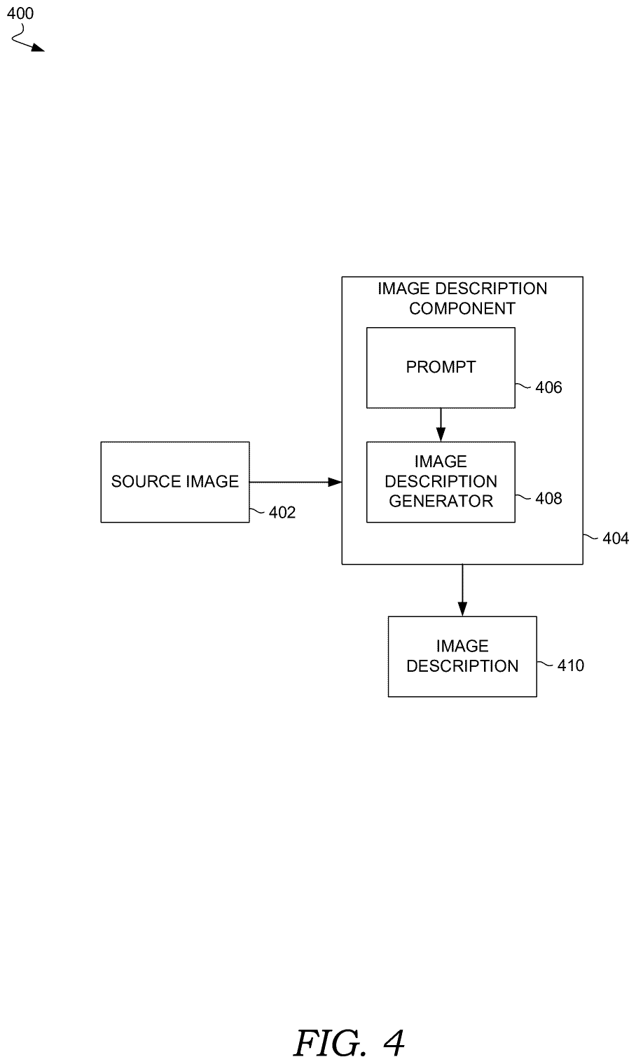

FIG. 4 is a block diagram 400 illustrating an example subsystem for generating image descriptions, in accordance with some implementations of the present disclosure. In some configurations, a source image 402 (e.g., a source image such as source image 202) is received from a user device such as user device 102 by an image description component 404 (e.g., an image description component 112). In some configurations, the image description component 404 generates, receives, or otherwise is provided with a prompt 406 to generate a description of source image 402, as described above. In some configurations, the prompt 406 is provided to an image description generator 408, which performs one or more operations to generate an image description 410. In at least one embodiment, the image description generator 408 is a multi-modal language model such as a multi-modal LLM. In at least one embodiment, the image description generator 408 is an off-the-shelf LLM such as GPT-4. In at least one embodiment, the image description generator 408 is a custom LLM, fine-tuned to provide an image description of source image 402. In at least one embodiment, not illustrated in FIG. 4, a subsystem for generating image descriptions receives additional data and/or metadata about source image 402, such as, for example, cultural information about source image 402.

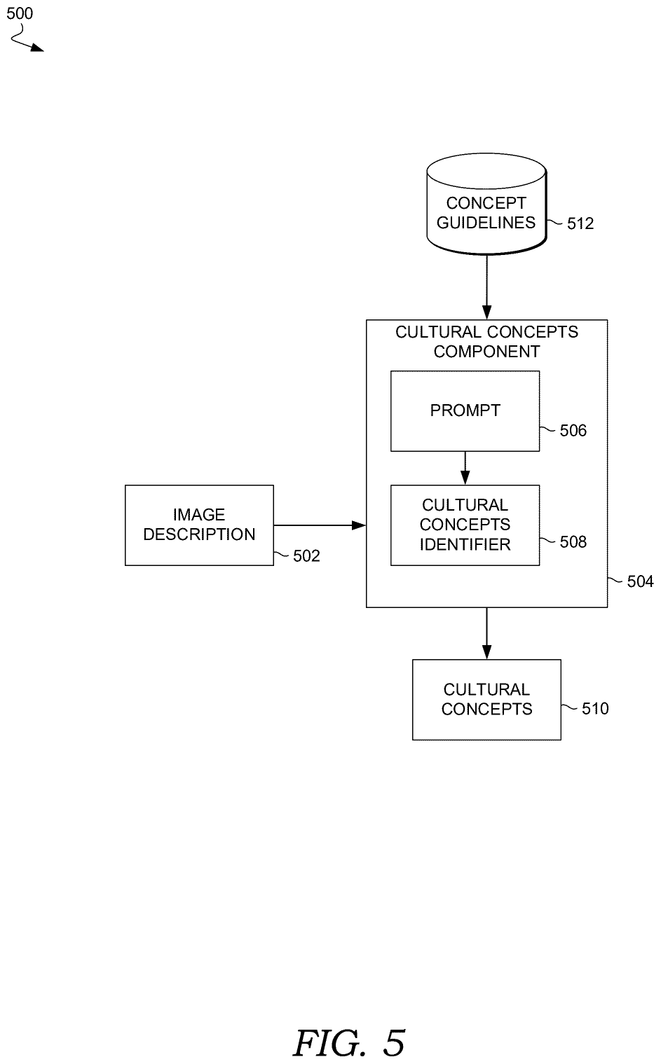

FIG. 5 is a block diagram 500 illustrating an example subsystem for identifying cultural concepts, in accordance with some implementations of the present disclosure. In some configurations, an image description 502 (e.g., an image description such as image description 206) is received from an image description component (e.g., an image description component such as image description component 112) by a cultural concepts component 504 (e.g., a cultural concepts component such as cultural concepts component 114). In some configurations, the cultural concepts component 504 generates, receives, or otherwise is provided with a prompt 506 to identify cultural concepts from the image description 502, as described above. In some configurations, the prompt 506 is provided to a cultural concepts identifier 508, which performs one or more operations to identify cultural concepts 510. In some configurations, cultural concepts 510 comprises a plurality of cultural concepts from image description 502 (e.g., two, three, four, etc. cultural concepts). In at least one embodiment, cultural concepts identifier 508 is a language model such as an LLM. In at least one embodiment, cultural concepts identifier 508 is an off-the-shelf LLM such as GPT-4. In at least one embodiment, cultural concepts identifier 508 is a custom LLM, fine-tuned to identify cultural concepts from image description 502. In at least one embodiment, not illustrated in FIG. 5, a subsystem for identifying cultural concepts receives additional data and/or metadata about the image description 502 such as, for example, cultural information associated with the image description 502. In some configurations, the cultural concepts identifier 508 identifies the cultural concepts 510 from the image description by leverage information identifying cultural concepts in a cultural guidelines hierarchy stored in a concept guidelines 512 datastore (e.g., a cultural concept guidelines datastore).

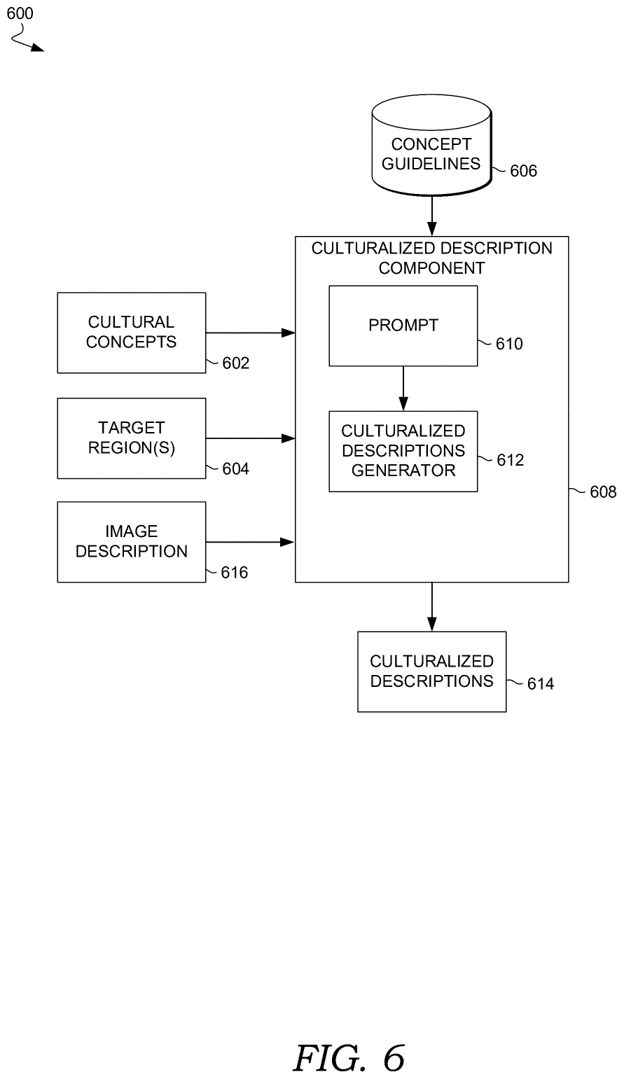

FIG. 6 is a block diagram 600 illustrating an example subsystem for generating culturalized descriptions, in accordance with some implementations of the present disclosure. In some configurations, cultural concepts 602 (e.g., cultural concepts such as cultural concepts 210) are received from a cultural concepts component (e.g., a cultural concepts component such as the cultural concepts component 114) by a culturalized description component 608 (e.g., a culturalized description component such as the culturalized description component 116). In some configurations, an image description 616 (e.g., an image description such as image description 206) is received from a cultural concepts component by the culturalized description component 608. In some configurations, one or more target regions (e.g., target regions such as target regions 214) are received from a user device such as user device 102 by the culturalized description component 608. In some configurations, cultural guidelines are retrieved from a cultural guidelines hierarchy in a concept guidelines 606 datastore (e.g., cultural guidelines such as cultural guidelines stored in the concept guidelines 212 datastore of FIG. 2) and are provided to the culturalized description component 608. In some configurations, the cultural guidelines are retrieved from the concept guidelines 606 datastore based on the cultural concepts 602 identified from the image description 616 for each target region 604. In some configurations, the culturalized description component 608 generates, receives, or otherwise is provided with a prompt 610 to generate culturalized descriptions based, at least in part, on the image description 616 and the cultural concepts 602, using target regions 604 and cultural guidelines from the concept guidelines 606 datastore, as described above. In some configurations, the prompt 610 is provided to a culturalized descriptions generator 612, which performs one or more operations to generate culturalized descriptions 614. In some configurations, culturalized descriptions 614 comprises one or more culturalized descriptions for each of target regions 604. In at least one embodiment, the culturalized descriptions generator 612 is a language model such as an LLM. In at least one embodiment, the culturalized descriptions generator 612 is an off-the-shelf LLM such as GPT-4. In at least one embodiment, the culturalized descriptions generator 612 is a custom LLM, fine-tuned to generate culturalized descriptions from cultural concepts 602, using target regions 604 and concept guidelines 606 datastore. In at least one embodiment, not illustrated in FIG. 6, a subsystem for generating culturalized descriptions receives additional data and/or metadata about cultural concepts 602 and/or target regions 604.

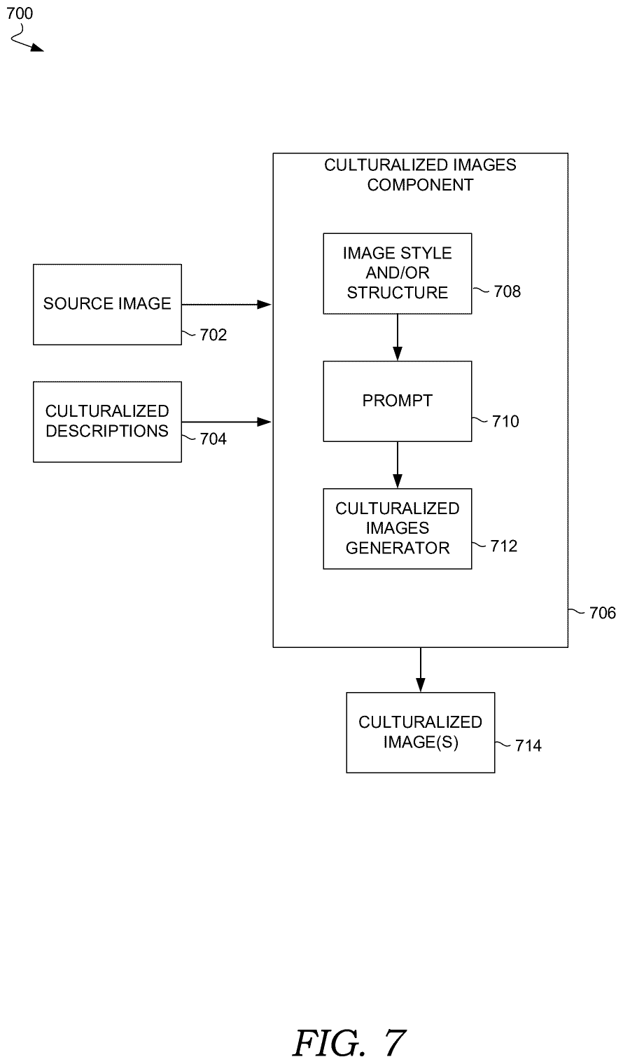

FIG. 7 is a block diagram 700 illustrating an example subsystem for generating culturalized images, in accordance with some implementations of the present disclosure. In some configurations, a source image 702 (e.g., a source image such as source image 202) is received from a user device such as user device 102 by a culturalized images component 706 (e.g., a culturalized images component such as culturalized images component 118). In some configurations, one or more culturalized descriptions 704 (e.g., culturalized descriptions such as culturalized descriptions 218) are received from a culturalized description component (e.g., a culturalized description component such as culturalized description component 116) by the culturalized images component 706. In some configurations, the culturalized images component 706 generates, receives, or otherwise is provided with a prompt 710 to generate one or more culturalized images based, at least in part, on the culturalized description(s) 704. In some configurations, the prompt 710 is based, at least in part, on image style and/or structure 708, which is derived from source image 702, as described herein. In some configurations, the prompt 710 is provided to a culturalized images generator 712, which performs one or more operations to generate one or more culturalized images 714. In at least one embodiment, the culturalized images generator 712 is a generative model (e.g., a generative artificial intelligence model) that generates images from natural language inputs such as, for example, DALL-E 3, Midjourney, or various diffusion models. In at least one embodiment, the culturalized images generator 712 is an off-the-shelf generative model. In at least one embodiment, the culturalized images generator 712 is a custom generative model, fine-tuned to generate culturalized images based on source image 702 using culturalized descriptions 704. In at least one embodiment, not illustrated in FIG. 7, a subsystem for generating culturalized images receives additional data and/or metadata about source image 702 and/or culturalized descriptions 704.

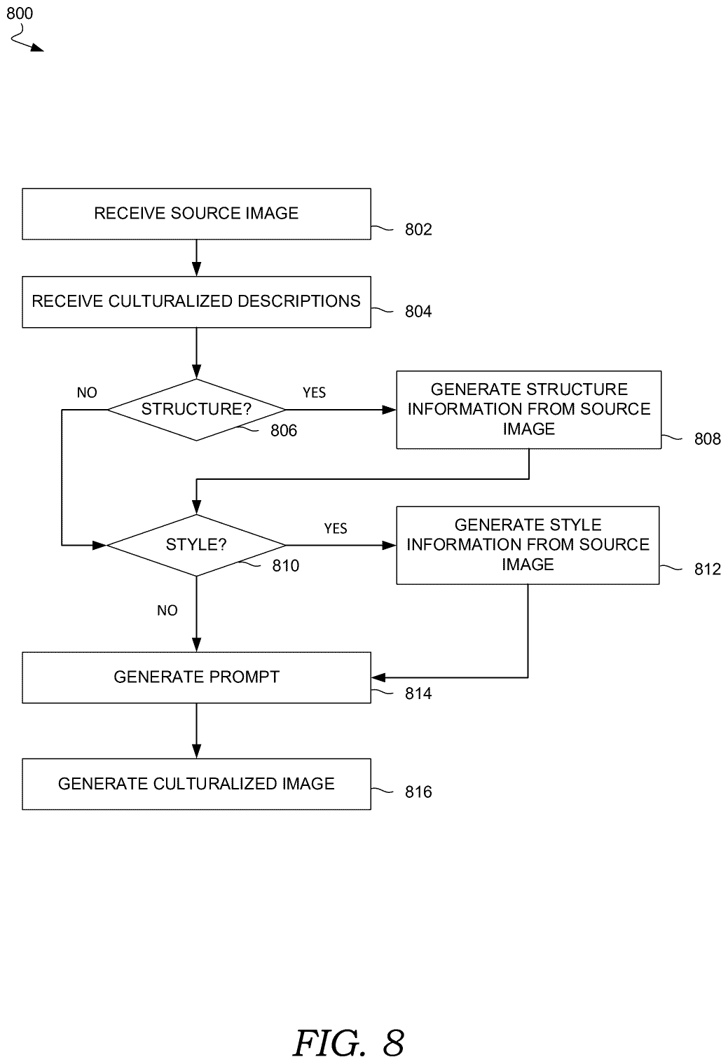

FIG. 8 is a flow diagram 800 illustrating a method for generating culturalized images, in accordance with some implementations of the present disclosure. The method illustrated in FIG. 8 can be performed by, for instance, the image culturalization system 104 described herein at least in connection with FIG. 1. The method illustrated in FIG. 8 can also be performed separately from the operations of the image culturalization system 104 (e.g., can be performed by a different component, not illustrated in FIG. 1, either as a pre-process or offline). Each block of the method illustrated in FIG. 8 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), a plug-in to another product, or other such applications, services, products, or plug-ins.

At block 802, a source image is received from a user device such as user device 102, described herein at least in connection with FIG. 1. In at least one embodiment, the source image received from the user device is specified using a user interface to, for example, drag and drop the source image for image culturalization. In at least one embodiment, the source image is stored in a storage location accessible by the method for generating a culturalized image illustrated in FIG. 8. In some configurations, the source image is one of a plurality of source images to be used in the method for generating a culturalized image illustrated in FIG. 8 (e.g., using a batch process).

At block 804, one or more culturalized descriptions are received from a culturalized description component such as the culturalized description component 116, described herein at least in connection with FIG. 1, as described herein. In at least one embodiment, the culturalized descriptions are stored in a storage location accessible by the method for generating culturalized images illustrated in FIG. 8. In some configurations, the culturalized descriptions comprise one or more culturalized descriptions of the source image for each of one or more target regions, as described above.

At block 806, the method for generating culturalized images performs one or more operations to determine whether structure information is to be generated for the source image received at block 802. In some configurations, a user indicates (e.g., via a user interface) whether to generate structure information that is to be used to generate a culturalized image. If structure information is to be generated for the source image (the “YES” branch), the method for generating culturalized images illustrated in FIG. 8 continues at block 808. If no structure information is to be generated for the source image (the “NO” branch), the method for generating culturalized images illustrated in FIG. 8 continues at block 810.

At block 808, structure information is generated for the source image received at block 802. In some configurations, structure information comprises information about the structure of the source image, such as the location of objects in the image, the overall structure of the image (e.g., whether it is a street scene, a pastoral scene, etc.), the placement of objects in comparison to each other, etc. In some configurations, the structure information is generated using a generative model such as those described herein. In some configurations, the structure information is obtained using an image generation module by analyzing the depth of images in the source image (e.g., the distance of objects from the camera or virtual camera used to obtain the image) and using that depth to identify the outline of the objects. Based on the identified outline, a mask corresponding to the outline is applied when generating a new image.

At block 810, the method for generating culturalized images performs one or more operations to determine whether style information is to be generated for the source image received at block 802. In some configurations, a user indicates (e.g., via a user interface) whether to generate style information that is to be used to generate a culturalized image. If style information is to be generated for the source image (the “YES” branch), the method for generating culturalized images illustrated in FIG. 8 continues at block 812. If no style information is to be generated for the source image (the “NO” branch), the method for generating culturalized images illustrated in FIG. 8 continues at block 814.

At block 812, style information is generated for the source image received at block 802. In some configurations, style information comprises information about the visual style of the source image, such as whether the source image is warm or cold, whether the source image is a photograph, what visual styles are used in the source image, etc. In some configurations, the style information is generated using a generative model such as those described herein. In some configurations, the style information is obtained using an image generation module by analyzing the depth of images in the source image (e.g., the distance of objects from the camera or virtual camera used to obtain the image) and using that depth to identify the outline of the objects. Based on the identified outline, a mask corresponding to the outline is applied when generating a new image.

At block 814, a prompt is generated that can be used by a generative model to generate a culturalized image. In some configurations, the prompt comprises information from the source image (e.g., received at block 802) and the culturalized description(s) (e.g., received at block 804), as described herein. In some configurations, the prompt also comprises structure information generated at block 808. In some configurations, the prompt also comprises style information generated at block 812. Then at block 816, the prompt generated at block 814 is used to generate a culturalized image using systems, methods, operations and techniques described herein. In some configurations, not shown in FIG. 8, after block 816, the method for generating culturalized images illustrated in block diagram 800 restarts at block 802 with a new source image.

Although not illustrated in FIG. 8, in some configurations, the operations of the method for generating culturalized images illustrated in flow diagram 800 are performed in a different order than that described. For example, block 814 could be performed before block 806, yielding a different prompt. In other words, a prompt could be generated that includes the source image and the culturalized description that instructs the generative model to generate a culturalized image from the culturalized description that matches the structure and/or style of the source image. In some configurations, where operations can be performed in a different order, some of the operations can be performed in parallel by a plurality of devices such as those described herein. Similarly, in some configurations, operations can be performed in a batch so that, for example, a plurality of culturalized images can be generated sequentially or in parallel for each region using a plurality of threads.

### Example Systems and Methods for Generating Cultural Guidelines

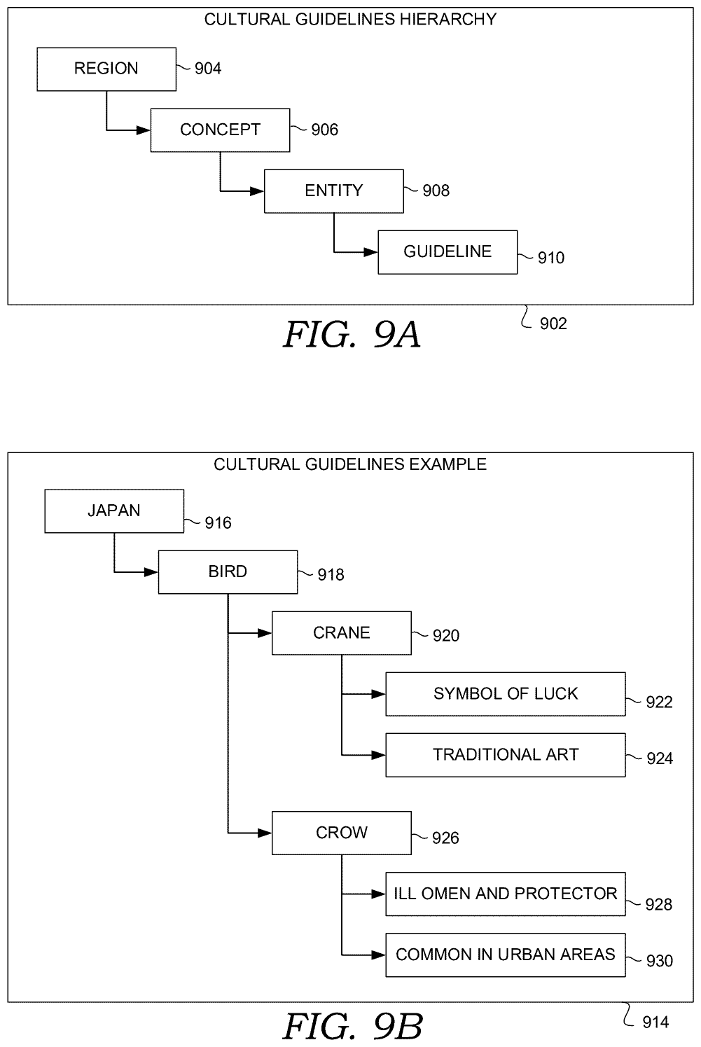

FIG. 9A is a block diagram illustrating a hierarchy of cultural guidelines, in accordance with some implementations of the present disclosure. A cultural guidelines hierarchy 902 includes, for each region 904, one or more cultural concepts 906, for each cultural concept 906, one or more entities 908, and for each entity 908, one or more cultural guidelines 910. In some configurations, cultural guidelines are used to inform cultural concepts (e.g., using a cultural concepts component 114) and are stored in the concept guidelines 212 datastore, as described herein. For example, the cultural guidelines hierarchy 902 can be used by a language model to both identify culturally relevant entities (e.g., for a particular region and concept) and to provide cultural guidelines for utilizing those entities when culturalizing an image. It should be noted that the cultural guidelines hierarchy 902 shown in FIG. 9A is one example of many possible cultural guidelines hierarchies. For example, a cultural guidelines hierarchy could be organized with concepts at the top level, regions below that, and then entities and guidelines below that. In another example, a cultural guidelines hierarchy could be organized with concepts at the top level, entities at the next level, and guidelines organized by region so that each entity would have one or more regions with corresponding guidelines. In some configurations, cultural guidelines can be stored with no hierarchy so that they can be accessed using a lookup (e.g., “find guidelines for birds culturally relevant to Japan”).

FIG. 9B is a block diagram illustrating an example of cultural guidelines, in accordance with some implementations of the present disclosure. The cultural guidelines example 914 shown in FIG. 9B uses the cultural guidelines hierarchy 902 shown in FIG. 9A where, for each region 904, there are one or more cultural concepts 906, for each cultural concept 906, there are one or more entities 908, and for each entity 908, there are one or more guidelines 910. The cultural guidelines example 914 shown in FIG. 9B has a single region “Japan” 916, a single concept “Bird” 918, two entities “Crane” 920 and “Crow” 926, two cultural guidelines for “Crane” (“Symbol of Luck” 922 and “Traditional Art” 924), and two cultural guidelines for “Crow” (“μl Omen and Protector” 928 and “Common in Urban Areas” 930). This cultural guidelines hierarchy enables a cultural concepts component 114 to identify cultural concepts in a source image (e.g., that a crane is a bird of Japan that is a symbol of luck and is used in traditional art). This cultural guidelines hierarchy also enables a culturalized description component 116 to generate a culturalized description. For example, if a source image includes a bird, and a target region for image culturalization is “Japan,” one or both of a crane or a crow can be used based on the cultural guidelines hierarchy (e.g., for an urban scene, a crow might be used in the culturalized description).

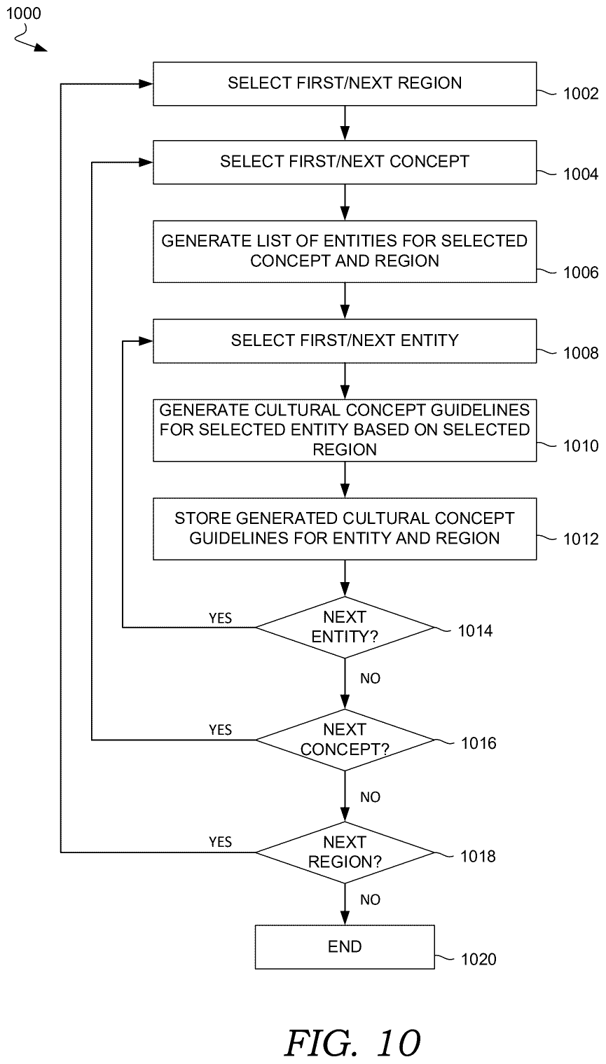

In some configurations, entities and cultural guidelines are generated for each cultural concept and each region manually. In some configurations, entities and cultural guidelines are generated for each cultural concept and each region using a language model (e.g., an LLM). For example, with a list of regions and a list of entities, a series of prompts can be provided to the LLM, as described below in FIG. 10.

FIG. 10 is a flow diagram 1000 illustrating a method for generating and storing structured data for a cultural guidelines hierarchy, in accordance with some implementations of the present disclosure. The method illustrated in FIG. 10 can be performed by, for instance, the image culturalization system 104, described herein at least in connection with FIG. 1. The method illustrated in FIG. 10 can also be performed separately from the operations of the image culturalization system 104 (e.g., can be performed by a different component, not illustrated in FIG. 1, either as a pre-process or offline). Each block of the method illustrated in FIG. 10 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), a plug-in to another product, or other such applications, services, products, or plug-ins.

At block 1002, a first region from a list of regions is selected. For example, if a list of regions comprises {“Japan”, “India”, “Brazil”}, at a first iteration of block 1002, “Japan” is selected. In subsequent iterations of block 1002, “India” and then “Brazil” are selected. In some configurations, the list of regions is received from a user device such as user device 102, described herein at least in connection with FIG. 1. In some configurations, the list of regions is manually generated. In some configurations, the list of regions is automatically generated. In some configurations, the list of regions comprises countries, cultures, and/or subcultures within those countries or cultures.

At block 1004, a first concept from a list of concepts is selected. For example, if a list of concepts comprises {“Bird”, “Food”, “Plant”, “Flower”}, at a first iteration of block 1004, “Bird” is selected. In subsequent iterations of block 1004, “Food”, then “Plant”, and then “Flower” are selected. In some configurations, the list of concepts is received from a user device such as user device 102, described herein at least in connection with FIG. 1. In some configurations, the list of concepts is manually generated. In some configurations, the list of concepts is automatically generated.

At block 1006, a list of entities for the region selected at block 1002 and the concept selected at block 1004 is generated. In some configurations, the list of entities is generated using a language model such as a LLM. For example, if the region selected at block 1002 is “Japan” and the concept selected at block 1004 is “Bird,” then a prompt to a language model such as “Give me a list of birds that are important in Japan” or “List ten birds that are culturally important in Japan” could provide the list of entities.

At block 1008, a first entity of the list of entities generated at block 1006 is selected. For example, if the list of entities generated at block 1006 comprises {“Crane”, “Crow”}, at a first iteration of block 1008, “Crane” is selected and at a second iteration of block 1008, “Crow” is selected.

At block 1010, one or more cultural guidelines are generated for the entity selected at block 1008 and the region selected at block 1002. In some configurations, the one or more cultural guidelines are generated using a language model such as a LLM. For example, if the region selected at block 1002 is “Japan” and the entity selected at block 1008 is “Crane,” then a prompt to a language model such as “Give me one to three Japanese cultural guidelines for a Crane” could provide the one or more cultural guidelines.

At block 1012, the cultural guidelines generated at block 1010 are stored in a cultural guidelines datastore, such as the concept guidelines 212 datastore of FIG. 2, as described herein. In some configurations, the cultural guidelines generated at block 1010 are stored according to a hierarchy such as that described in connection with FIGS. 9A and 9B.

At block 1014, the method for generating and storing structured data for cultural guidelines performs operations to determine whether to process a next entity (e.g., whether to perform blocks 1010 and 1012 for a different entity in the list of entities generated at block 1006). If a next entity is available for processing (the “YES” branch), the method continues at block 1008 to select the next entity for processing. If a next entity is not available for processing (the “NO” branch), the method continues at block 1016.

At block 1016, the method for generating and storing structured data for cultural guidelines performs operations to determine whether to process a next concept (e.g., whether to perform blocks 1006-1014 for a different concept in the list of concepts). If a next concept is available for processing (the “YES” branch), the method continues at block 1004 to select the next concept for processing. If a next concept is not available for processing (the “NO” branch), the method continues at block 1018.

At block 1018, the method for generating and storing structured data for cultural guidelines performs operations to determine whether to process a next region (e.g., whether to perform blocks 1004-1016 for a different region in the list of regions). If a next region is available for processing (the “YES” branch), the method continues at block 1002 to select the next region for processing. If a next region is not available for processing (the “NO” branch), the method continues at block 1020. In some configurations, at block 1020, the method for generating and storing structured data for cultural guidelines illustrated in block diagram 1000 ends. In some configurations, not shown in FIG. 10, after block 1018, the method for generating and storing structured data for cultural guidelines illustrated in block diagram 1000 restarts at block 1002 with a new set of regions and concepts.

Although not illustrated in FIG. 10, in some configurations, the operations of the method for generating and storing structured data for cultural guidelines illustrated in block diagram 1000 are performed in a different order than that described. For example, block 1004 could be performed before block 1002, yielding a different hierarchy, as described in connection with FIGS. 9A and 9B. In some configurations, where operations can be performed in a different order, some of the operations can be performed in parallel by a plurality of devices such as those described herein. Similarly, in some configurations, operations can be performed in a batch so that, for example, a plurality of guidelines can be generated sequentially or in parallel for each concept and region, or each region and/or concept could be processed in parallel using a plurality of threads.

### Exemplary Operating Environment

Having described implementations of the present disclosure, an exemplary operating environment in which embodiments of the present technology can be implemented is described below in order to provide a general context for various aspects of the present disclosure. Referring initially to FIG. 11 in particular, an exemplary operating environment for implementing embodiments of the present technology is shown and designated generally as computing device 1100. Computing device 1100 is but one example of a suitable computing environment and is not intended to suggest any limitation as to the scope of use or functionality of the technology. Neither should the computing device 1100 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 11, computing device 1100 includes bus 1110 that directly or indirectly couples the following devices: memory 1112, one or more processors 1114, one or more presentation components 1116, input/output (I/O) ports 1118, input/output components 1120, and illustrative power supply 1122. Bus 1110 represents what can be one or more busses (such as an address bus, data bus, or combination thereof). Although the various blocks of FIG. 11 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 11 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 11 and reference to “computing device.”

Computing device 1100 typically includes a variety of computer-readable media. Computer-readable media can be any available media that can be accessed by computing device 1100 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1100. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1112 includes computer storage media in the form of volatile and/or nonvolatile memory. The memory can be removable, non-removable, or a combination thereof. Exemplary hardware devices include solid-state memory, hard drives, optical-disc drives, etc. Computing device 1100 includes one or more processors that read data from various entities such as memory 1112 or I/O components 1120. Presentation component(s) 1116 present data indications to a user or other device. Exemplary presentation components include a display device, speaker, printing component, vibrating component, etc.

I/O ports 1118 allow computing device 1100 to be logically coupled to other devices including I/O components 1120, some of which can be built in. Illustrative components include a microphone, joystick, game pad, satellite dish, scanner, printer, wireless device, etc. The I/O components 1120 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 1100. The computing device 1100 can be equipped with depth cameras, such as, stereoscopic camera systems, infrared camera systems, RGB camera systems, and combinations of these for gesture detection and recognition. Additionally, the computing device 1100 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
generating, using a first model, a first description of a first image;
identifying one or more cultural guidelines based, at least in part, on the first description and a target region;
generating, using a second model, a second description based on the first description and the cultural guidelines; and
generating, using a third model, a second image using the second description.

2. The one or more computer storage media of claim 1, wherein the one or more cultural guidelines are identified using data stored in a cultural guidelines datastore.

3. The one or more computer storage media of claim 2, wherein the one or more cultural guidelines are identified by:
identifying, using a fourth model, one or more cultural concepts from the first description; and
retrieving, from the cultural guidelines datastore, the one or more cultural guidelines based, at least in part, on the one or more cultural concepts identified in the first description and the target region.

4. The one or more computer storage media of claim 3, wherein the one or more cultural guidelines comprise a first cultural guideline and a second cultural guideline, the first cultural guideline for a first cultural concept from the one or more cultural concepts, the second cultural guideline for a second cultural concept from the one or more cultural concepts.

5. The one or more computer storage media of claim 3, wherein the one or more cultural guidelines comprise a first cultural guideline and a second cultural guideline, the first cultural guideline for a first entity corresponding to a first cultural concept from the one or more cultural concepts, the second cultural guideline for a second entity corresponding to the first cultural concept.

6. The one or more computer storage media of claim 1, wherein generating the first description of the first image comprises:
generating a plurality of descriptions of the first image; and
selecting the first description from the plurality of descriptions.

7. The one or more computer storage media of claim 1, wherein generating the second description comprises:
generating a plurality of second descriptions based on the first description; and
selecting the second description from the plurality of second descriptions.

8. The one or more computer storage media of claim 1, wherein:
the target region is one of a plurality of target regions; and
generating the second description based on the first description comprises generating a second description for each of the plurality of target regions.

9. The one or more computer storage media of claim 1, wherein generating the second image using the second description comprises:
generating style information of the first image;
generating structure information of the first image; and
generating the second image using the second description based, at least in part, on the style information and the structure information.

10. A computer-implemented method comprising:
generating, using a first generative model, an image description of a source image;
identifying, using a second generative model, one or more cultural concepts in the image description;
identifying, from a cultural guidelines datastore, one or more cultural guidelines based, at least in part, on the one or more cultural concepts and a target region;
generating, using a third generative model, a culturalized description based, at least in part, on the image description and the cultural guidelines; and
generating, using a fourth generative model, a culturalized image using the culturalized description.

11. The computer-implemented method of claim 10, further comprising:
generating the cultural guidelines datastore comprising a set of target regions, a set of cultural concepts for at least one target region of the set of target regions, a set of entities for at least one cultural concept of the set of cultural concepts, and a set of cultural guidelines for at least one entity of the set of entities.

12. The computer-implemented method of claim 10, wherein the image description of the source image is generated using at least a portion of the set of cultural concepts from the cultural guidelines datastore.

13. The computer-implemented method of claim 10, wherein the one or more cultural concepts are identified using at least a portion of the set of cultural concepts from the cultural guidelines datastore.

14. The computer-implemented method of claim 10, wherein generating the image description of the source image comprises:
generating a plurality of descriptions of the source image; and
selecting the image description from the plurality of descriptions.

15. The computer-implemented method of claim 10, wherein generating the culturalized description comprises:
generating a plurality of descriptions based on the image description and the cultural guidelines; and
selecting the cultural description from the plurality of descriptions.

16. A computer system comprising:
one or more processors; and
one or more computer storage media storing computer-useable instructions that, when used by the one or more processors, causes the computer system to perform operations comprising:
generating, using a first generative model, an image description of a source image;
identifying, using a second generative model, one or more cultural guidelines from the source image based, at least in part, on the image description and a target region;
generating, using a third generative model, a culturalized description of the source image based, at least in part, on the image description and the one or more cultural guidelines; and
generating, using a fourth generative model, at least one culturalized image using the culturalized description of the source image.

17. The computer system of claim 16, wherein the one or more cultural guidelines are identified using data stored in a cultural guidelines datastore.

18. The computer system of claim 16, wherein the one or more cultural guidelines are identified by:
identifying one or more cultural concepts from the image description; and
retrieving, from a cultural guidelines datastore, the one or more cultural guidelines based, at least in part, on the one or more cultural concepts identified in the image description and the target region.

19. The computer system of claim 18, wherein the cultural guidelines datastore comprises a cultural guidelines hierarchy.

20. The computer system of claim 16, wherein the culturalized description of the source image is generated based, at least in part, on style and structure of the source image.
